(19) United States
(12) Patent Application Publication
(10) Pub. No.: US 2008/0216685 A1
(43) Pub. Date: Sep. 11, 2008

(54) METHOD AND APPARATUS FOR MEASURING COLOR DENSITY OF A COLOR BAR IN A PRINTING PRESS, AND PRINTING PRESS EQUIPPED WITH COLOR DENSITY MEASURING APPARATUS

(76) Inventor: Takeshi Omoto, Fuchu-shi (JP)

Correspondence Address: PERKINS COIE LLP, P.O. BOX 1208, SEATTLE, WA, 98111-1208, US

(21) Appl. No.: 12/036,071

(22) Filed: Feb. 22, 2008

(30) Foreign Application Priority Data
Mar. 6, 2007 (JP) 2007-055580

(51) Int. Cl. B41M 1/14

(52) U.S. Cl. 101/211

(57) ABSTRACT

It is an object of the present invention to provide a method and apparatus that is capable of highly accurately measuring the color density of a color bar in a printing press by a simple structure, and a printing press equipped with the color density measuring apparatus. There is provided a method of measuring the color density of a color bar of each of print mediums in a printing press, in which each of print mediums is printed and imaged before it is discharged from the printing press, and the color density of the imaged print medium is measured. Specifically, the method includes: storing the shape and the color information of a basic color patch of a color bar of a print medium; imaging the entire area of each of printed print mediums; storing an image of the entire area of the imaged print medium; scanning a particular area of the stored image, said particular area containing a basic color patch of a color bar of the imaged print medium, on the basis of the previously stored shape and color information of the basic color patch, thereby searching out the basic color patch of the imaged print medium; storing the position of the searched out basic color patch of the print medium; and recognizing the position of the color bar from the stored position of the basic color patch and measuring the color density of the color bar.

### CROSS REFERENCE TO RELATED APPLICATION

This application claims priority to Japanese Patent Application No. 2007-55580, filed Mar. 6, 2007, and entitled “Method And Apparatus For Measuring Color Density Of A Color Bar In A Printing Press, And Printing Press Equipped with Color Density Measuring Apparatus” by Takeshi Omoto, and is incorporated herein by reference.

### BACKGROUND OF THE INVENTION

1. Field of the Invention

The present invention relates to a method of measuring a color density of a color bar of each of print mediums in a printing press before it is discharged from the printing press after printing, an apparatus for measuring the color density of a color bar in a printing press, and a printing press equipped with a color density measuring apparatus for performing feedback on the basis of the measured color density value.

2. Related Art

There has been hitherto proposed an art, in which when the color density has been changed during printing operation, its density difference is automatically corrected to enable the actual color density to be brought back to a preset color density. Specifically, the color density of each of print mediums subsequently printed is measured, and the amount of ink to be supplied in each of ink fountain keys is adjusted to match the measured color density to a preset color density. More specifically, a color bar that is made up of a number of color patches and a cruciform reference mark located between the adjacent color patches are printed on each print medium, then image data of the print medium is stored, then the intersecting point of the reference mark is detected, and then the relative position of the color bar is presumed on the basis of this detected information. Subsequently, on the basis of this relative-position information, pixels that form one color patch of a number of the color patches stored and its periphery are extracted. Then, a predetermined number of data rows, each row made up of a predetermined number of pixel values, are extracted from these extracted pixels, then the distribution of the extracted pixel values is calculated, and then the center of the color patch is detected on the basis of this distribution. Then, a pixel of the color patch at the center is retrieved from the stored image data, and the color density of the color patch of the retrieved image data is measured (cf. Patent Document 1).

3. Patent Document 1: Japanese Patent Application Laid-open No. 2003-103762

According to the disclosure of Patent Document 1, in a time before image data of a color patch at the center is retrieved from image data, a number of steps, which include a step of detecting the intersecting point of a reference mark, a step of presuming the relative position of the color bar on the basis of this detecting step, and a step of detecting the center of the color patch by extracting pixels that form one color patch and its periphery, must not only be carried out, but also there is a disadvantage in that a highly accurate control device must be used since the position of the color bar must be presumed upon the detection of the reference mark.

### SUMMARY OF THE INVENTION

The present invention has been conceived in order to solve the above problems. It is an object of the present invention to provide a method and apparatus that is capable of highly accurately measuring the color density of a color bar in a printing press by a simple structure, and a printing press equipped with the color density measuring apparatus.

According to one aspect of the present invention, there is provided a method of measuring the color density of a color bar of each of print mediums in a printing press, in which each of print mediums is printed and imaged before it is discharged from the printing press, and the color density of the imaged print medium is measured. The method includes: storing the shape and the color information of a basic color patch of a color bar of a print medium; imaging the entire area of each of printed print mediums; storing an image of the entire area of the imaged print medium; scanning a particular area of the stored image, the particular area containing a basic color patch of a color bar of the imaged print medium, on the basis of the previously stored shape and the color information of the basic color patch, thereby searching out the basic color patch of the imaged print medium; storing the position of the searched out basic color patch of the print medium; and recognizing the position of the color bar from the stored position of the basic color patch and measuring the color density of the color bar.

According to another aspect of the present invention, there is provided a color density measuring apparatus for measuring the color density of each of print mediums in a printing press, in which an imaging means is disposed to image each of printed print mediums before it is discharged from the printing press. The apparatus includes: a basic color patch storing means for storing the shape and the color information of a basic color patch of a color bar of a print medium; an image storing means for storing an image of the entire area of each of the print mediums imaged by the imaging means; a scanning means for scanning a particular area containing the basic color patch of the image stored by the image storing means; a position storing means for storing the position of the basic color patch of each of the printed mediums by searching out the basic color patch of each of the print mediums by scanning the particular area on the basis of the shape and the color information of the basic color patch stored by the basic color patch storing means; a position recognition means for recognizing the position of the color bar on the basis of the position of the basic color patch stored by the position storing means; and a color density measuring means for measuring the color density of the color bar recognized by the position recognition means.

The basic color patch is of, for example, a rectangular shape (outline) having Cyan (C), Magenta (M), Yellow (Y) and Black (K) aligned each other when a four-color printing press is employed. The present inventors focused attention on the fact that this basic color patch is located at the same position in a sheet width direction (a lateral direction orthogonal to the conveying direction) regardless of the size of the sheet of paper, and found that it is possible to easily and instantly detect the position of a basic color patch of a printed print medium by utilizing the above fact on the basis of the shape and the color information (e.g., color density), of a basic color patch that is previously stored. That is, a basic color patch of a print medium is previously stored, and then a particular area containing a basic color patch of an image of the entire area of a print medium imaged on the basis of the previously stored shape and color information of the basic color patch is scanned, thereby enabling the basic color patch to be instantly searched out on the basis of the previously stored basic color patch. Since the other color patches are located on the opposite sides of this basic color patch and aligned side by side with each other, the entire color bar can be instantly recognized and thereby the color densities of all the color patches of the color bar can be instantly measured.

The above method may further include checking whether the position of the basic color patch of the stored image of each of second and subsequent print mediums is matched to the position of the basic color patch of the stored image of a first print medium, so that if they are not matched, the amount of displacement in the x and y axes of a coordinate system is computed, and coordinate interpolation is performed according to the result of the computation.

In the above method, it is possible to employ an arrangement, in which the particular area has a lateral width greater than the lateral width of the basic color patch that is located at the center along the lateral direction of each of the print mediums, and each of the print mediums is scanned over the lateral width of the particular area in a direction in which each of the print mediums is conveyed.

According to still another aspect of the present invention, there is provided a printing press that includes any one of the above color density measuring apparatuses, a computation means for computing the density difference between a color density measured by the color density measuring means and a preset color density, and an ink amount adjusting means for adjusting the amount of ink to be supplied for each of plural ink fountain keys according to the density difference computed by the computation means.

In the above printing press, the print mediums may be printed sheets of paper. The printing press may further includes a first detection means for detecting the leading edge of an upcoming print medium in the conveying direction, a second detection means for detecting the leading edge of the upcoming print medium after elapsing a predetermined time from a time at which the first detection means has detected the same, and an imaging start instruction means for outputting an imaging start signal to the imaging means on the basis of an ON signal of the first detection means and an ON signal of the second detection means.

The printing press may further include a conveying speed detection means for detecting the conveying speed of the sheets of paper, the speed detection means being provided in a sheet supply section for supplying unprinted sheets of paper, and a speed limiting means for limiting the maximum conveying speed of the sheet supply section on the basis of a conveying speed value transmitted from the conveying speed detection means so as not to convey the sheets of paper at a speed equal to or higher than the limit imaging speed of the imaging means, at which the imaging means cannot appropriately perform imaging.

As compared with a prior art, in which the position of a color bar is detected upon detection of the intersecting point of a reference mark, the prevent invention can provide a method and apparatus for measuring the color density of a color bar in a printing press and a printing press equipped with a color density measuring apparatus that can not only instantly search out the basic color patch by a simple arrangement, but also easily and highly accurately measure the color densities of all the color patches from the stored basic color patch by previously storing the shape and the color information of a basic color patch of a print medium and then scanning a particular area containing a basic color patch of an image of the entire area of an imaged and stored print medium.

As mentioned above, it is checked whether the position of the basic color patch of the stored image of each of second and subsequent print mediums is matched to the position of the basic color patch of the stored image of a first print medium, so that if they are not matched, the amount of displacement in the x and y axes of a coordinate system is computed, and coordinate interpolation is performed according to the result of the computation. Whereby, it is possible to appropriately perform the density measuring even when an error has occurred during measuring due to involvement of displacement.

By the interpolation is meant a technique for inserting reasonable values between the discrete computed values. According to a simplest manner, the respective computed values are interconnected by a straight line. However, the interconnecting line may not be smoothened. Therefore, the interpolation is generally meant a technique for smoothly interconnecting the computed values.

When the particular area has a lateral width greater than the lateral width of the basic color patch that is located at the center along the lateral direction of each of the print mediums, and each of the print mediums is scanned over the lateral width of the particular area in a direction in which each of the print mediums is conveyed, it is possible to securely scan the particular area of each of print mediums along with the conveyance of the print mediums even by the imaging means secured in position without the necessity to move the same.

When the printing press includes a computation means for computing the density difference between a color density measured by the color density measuring means and a preset color density, and an ink amount adjusting means for adjusting the amount of ink to be supplied for each of plural ink fountain keys according to the density difference computed by the computation means, it is possible to automatically adjust the amount of ink so as to match the actual color density to a preset color density.

When the printing press further includes a first detection means for detecting the leading edge of an upcoming print medium in the conveying direction; a second detection means for detecting the leading edge of the upcoming print medium after elapsing a predetermined time from a time at which the first detection means has detected the same, and an imaging start instruction means for outputting an imaging start signal to the imaging means on the basis of an ON signal of the first detection means and an ON signal of the second detection means, it is possible to securely detect the presence of each print medium by the two different detection means, and thus the detection operation can be made with high reliability without causing erroneous outputting of an imaging start signal.

When the printing press further includes a conveying speed detection means for detecting the conveying speed of the sheets of paper, the speed detection means being provided in a sheet supply section for supplying unprinted sheets of paper, and a speed limiting means for limiting the maximum conveying speed of the sheet supply section on the basis of a conveying speed value transmitted from the conveying speed detection means so as not to convey the sheets of paper at a speed equal to or higher than the limit imaging speed of the imaging means, it is possible to appropriately perform the imaging operation without any troubles during color density measuring, since sheets of paper are not conveyed, during imaging by the imaging means, at a speed equal to or higher than the limit imaging speed, at which the imaging means cannot appropriately perform imaging.

### BRIEF DESCRIPTION OF THE DRAWINGS

FIG. 1(a) is a schematic control block diagram of a color density measuring apparatus, and FIG. 1(b) is a control block diagram for controlling a driving motor by output signals from an encoder.

FIG. 2 is a flowchart for performing color density measurement.

FIG. 3 is a schematic view of a printing section.

FIG. 4 is a time chart of output signals of two sensors.

FIGS. 5(a) and 5(b) illustrate the positions of a CCD camera and two sensors, in which FIG. 5(a) is a side view thereof and FIG. 5(b) is a perspective view thereof.

FIG. 6 is a plan view of a print medium.

FIG. 7 is a control block diagram illustrating the detail of a color density measuring apparatus.

### DETAILED DESCRIPTION OF THE PREFERRED EMBODIMENT

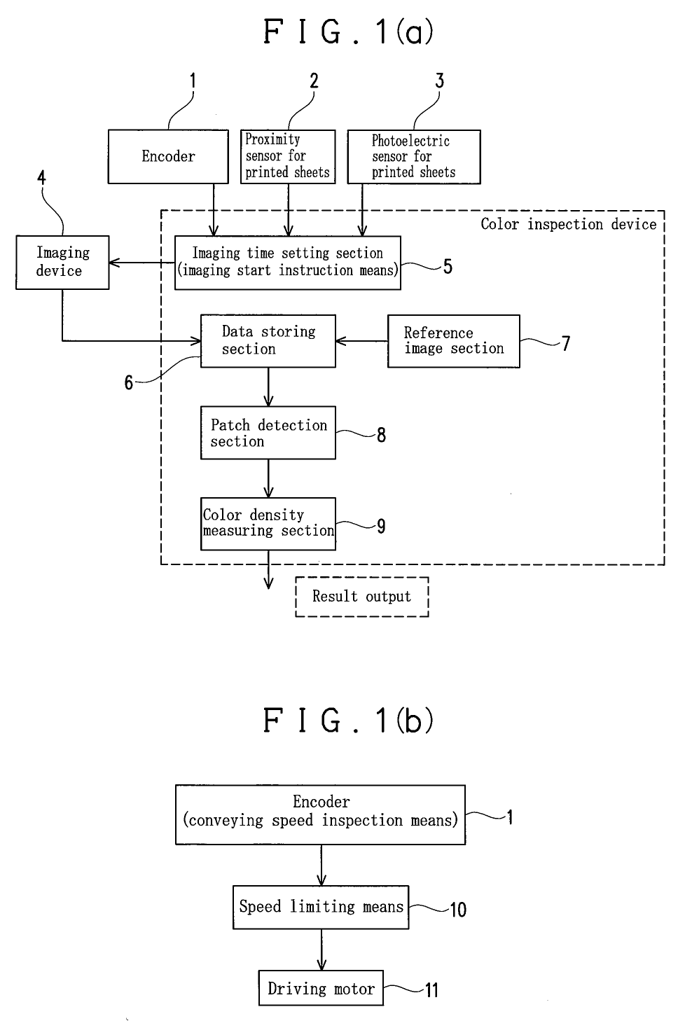

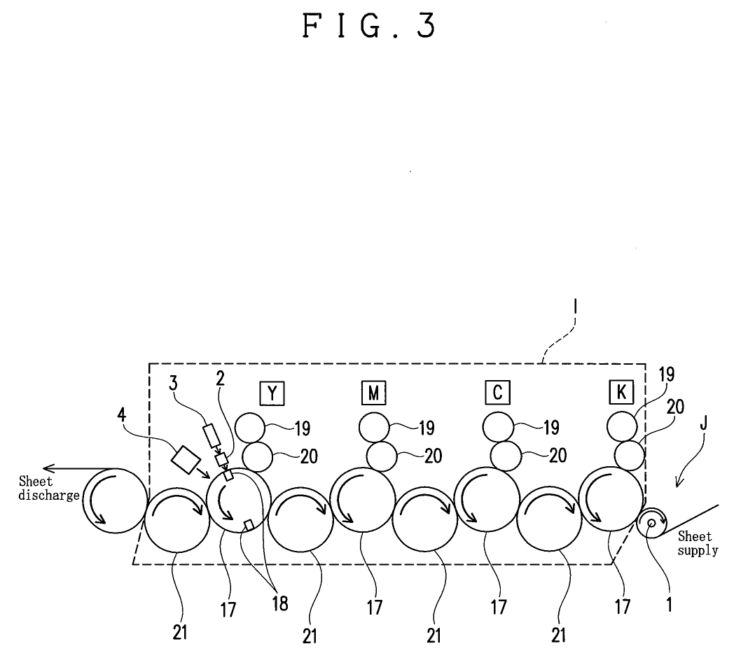

Now, the description will be made for an embodiment of the present invention with reference to the drawings attached hereto. FIG. 1 is a control block diagram (schematic diagram) of a color density measuring apparatus of the present invention. This color density measuring apparatus includes an encoder 1 disposed in a sheet supply section J (cf. FIG. 3), a proximity sensor 2 that is disposed on a terminal end side for detecting printed sheets and more specifically for detecting each print medium immediately after it has been printed, a photoelectric sensor 3 that is disposed on a terminal end side for detecting printed sheets and more specifically for detecting each print medium immediately after it has been printed, an imaging device 4, and a color inspection device into which image data from the imaging device 4 and output signals from the encoder 1, the proximity sensor 2 and the photoelectric sensor 3 are inputted. The color inspection device includes an imaging time setting section 5 for setting a period of time, for which imaging is performed, to a CCD camera 4 as an imaging device, a data storing section 6 for storing as data an image of the entire area of a print medium imaged by the CCD camera 4, a reference image section 7 for inputting as data a reference image (image of a basic color patch) into the data storing section 6, a patch detection section 8 for searching out a basic color patch from data (image) stored in the data storing section 6 on the basis of the shape (outline) and the color information of a reference image (basic color patch) from the reference image section 7, and a color density measuring section 9 for measuring the color density of the entire color bar having color patches located on the opposite sides of the searched out or detected basic color patch and aligned side by side with each other. It is to be noted that this color inspection device may have a different structure. Data representative of color density values measured at the color density measuring section 9 is transmitted to a control section at which the opening degree of each ink fountain key is adjusted, while at the same time the result is outputted by using a printer or the like. It is possible to use a line-sensor or the like in place of the CCD camera 4.

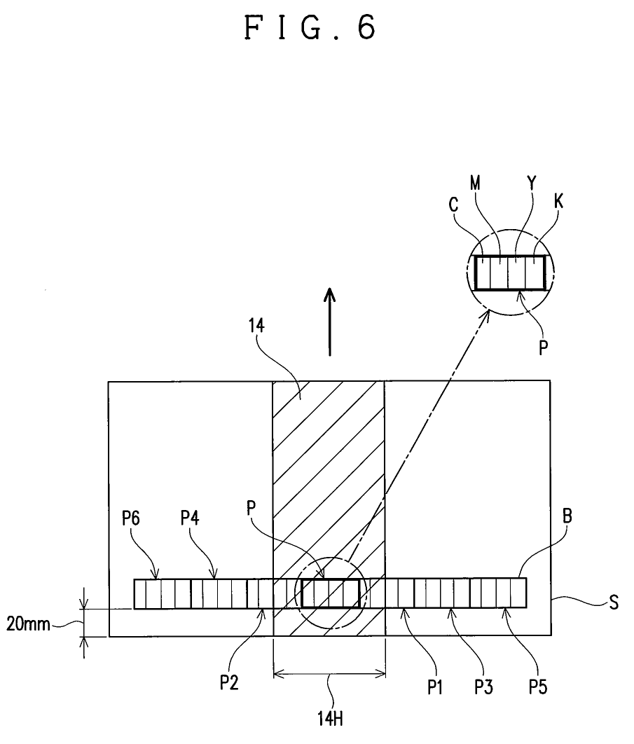

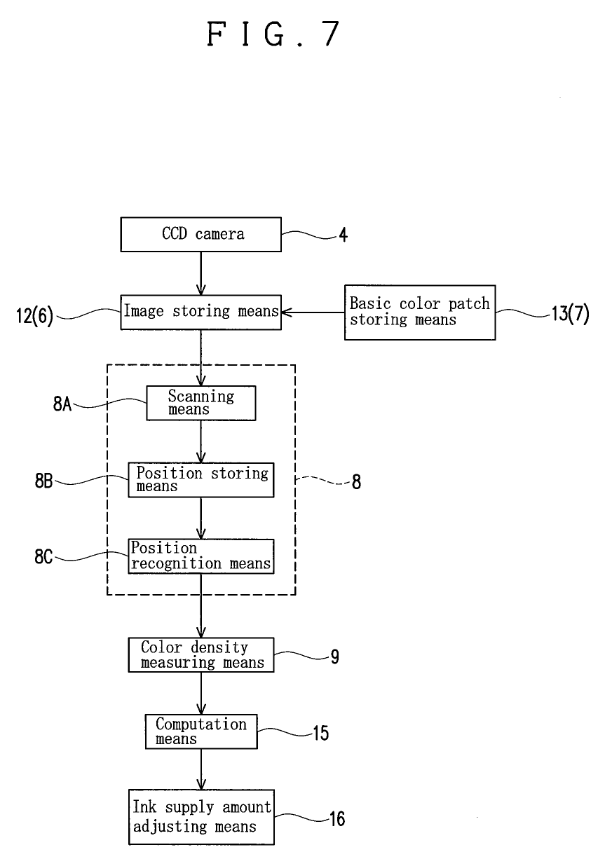

Giving a detailed explanation of the color inspection device, as illustrated in FIG. 7, the data storing section 6 includes an image storing means 12 for storing an image of the entire area of a print medium imaged by the imaging means, and the reference image section 7 includes a basic color patch storing means 13 for storing a basic color patch of a print medium. The patch detection section 8 includes a scanning means 8A for scanning a particular area 14 (cf. FIG. 6) of an image stored in the image storing means 12, which area contains a basic color patch that is located at the center along the lateral direction of the print medium; a position storing means 8B for storing the position of a basic color patch of a print medium by searching out the basic color patch upon scanning by the scanning means 8A on the basis of the shape and the color information of the basic color patch stored in the basic color patch storing means 13; and a position recognition means 8C for recognizing the position of the entire color bar from the position of the basic color patch stored in the position storing means 8B. The color density measuring section 9 is made up of a color density measuring means for measuring the color density of a color bar recognized by the position recognition means 8C. The color density measured by the color density measuring section 9 and a preset target color density are computed by a computation means 15 and the computed result is outputted to an ink supply amount adjusting means 16 that adjusts the amount of ink to be supplied according to the computed result.

The basic color patch P is made up of four basic color inks of Cyan (C), Magenta (M), Yellow (Y) and Black (K) aligned in this order from the left to the right, as illustrated in FIG. 6, and this basic color patch P is located at the center along the lateral direction of a sheet of paper (hereinafter referred simply to a sheet) regardless of the size of the sheet. A number of color patches P1 to P6 are located on the opposite lateral sides of the basic color patch P and they are aligned side by side with each other, thus forming a color bar B. Then, the basic color patch P imaged by the CCD camera 4 is searched on the basis of the previously stored shape (herein, a rectangular shape) and the color densities (color densities of Cyan, Magenta, Yellow and Black), of the previously stored basic color patch P. When the basic color patch P has been searched out, a control device stores it like “the color bar B is positioned 20 mm away from an edge of the sheet”, as illustrated in FIG. 6. A lateral width 14H to be scanned is set to be slightly greater than the lateral width of the basic color patch P. Thus, an image of a print medium S is scanned over the lateral width 14H by capturing this image by the CCD camera 4 (luring conveyance of a print medium S in a direction of the arrow. Herein, the color density is measured as the color information of the basic color patch P, but alternatively, the hue may be measured.

The encoder 1 may be utilized as a sensor for detecting the position of a sheet at the terminal end of the sheet supply section J, as illustrated in FIG. 3, but may necessitate complicated controlling due to irregularity in phase difference such as when the number of units (herein four units are provided) or a reversal mechanism is provided. Therefore, in this embodiment, as illustrated in FIG. 1(a), an output signal from the encoder 1 is outputted to the image time setting section 5 of the CCD camera 4. Then, as illustrated in FIG. 1(b), the encoder 1 is used as a conveying speed detection means for detecting the conveying speed of sheets. A conveying speed value from the encoder (conveying speed detection means) 1 is inputted into the speed limiting means 10 to limit the maximum conveying speed of the sheet supply section. Thus, by the speed limiting means 10, sheets are prevented from being conveyed at a speed equal to or higher than the limit imagining speed of the CCD camera 4, at which the CCD camera 4 cannot appropriately perform imaging. Whereby, an appropriate imaging can be achieved without causing a trouble in measuring the color density. It is to be noted that this arrangement may be changed depending on needs and circumstances. Actually, when an output signal from the encoder 1 is inputted into the speed limiting means 10, and it has been determined that the speed is equal to or higher than the limit imaging speed, the speed limiting means 10 controls the rotation of a driving motor 11 for driving a conveying feeder of the sheet supply section J so as to reduce the speed thereof, so that the conveying speed of sheets is reduced to a speed slower than the limit imaging speed.

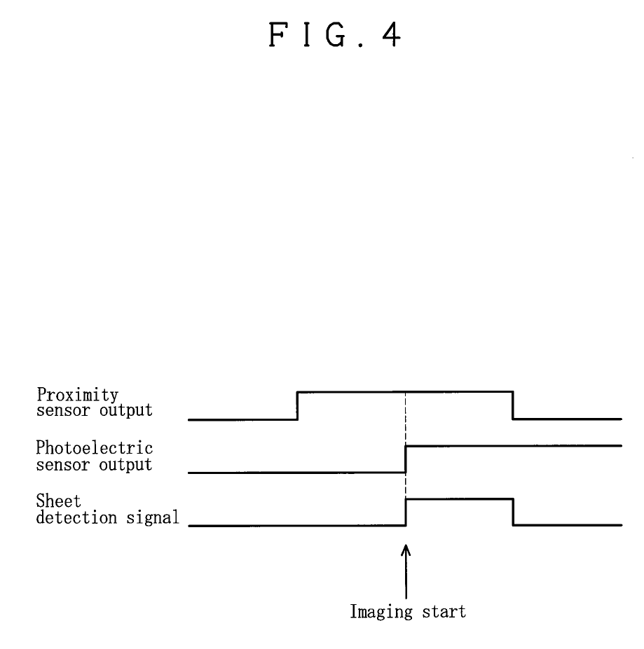

The proximity sensor 2 constitutes a first detection means for detecting the leading edge of an upcoming print medium in the sheet conveying direction, while the photoelectric sensor 3 constitutes a second detection means for detecting the leading edge of the upcoming print medium after elapsing a predetermined time from a time at which the first detection means 2 has detected the same. As illustrated in a time chart of FIG. 4, the imaging time setting section 5 outputs an imaging start signal to the CCD camera 4 on the basis of an ON signal of the first detection means 2 and an ON signal of the second detection means 3, thereby preventing outputting of an imaging start signal due to erroneous detection of a print medium. Specifically, a sheet detection signal or an imaging start signal is outputted after the photoelectric sensor 3 has turned on upon turn-on of the proximity sensor 2. The imaging time setting section 5 includes an imaging start instruction means that outputs an imaging start signal from the imaging time setting section 5 to the CCD camera 4. The imaging, which has been started by the CCD camera 4, is finished at the time when the number of lines set in a capture board has been inputted into the capture board.

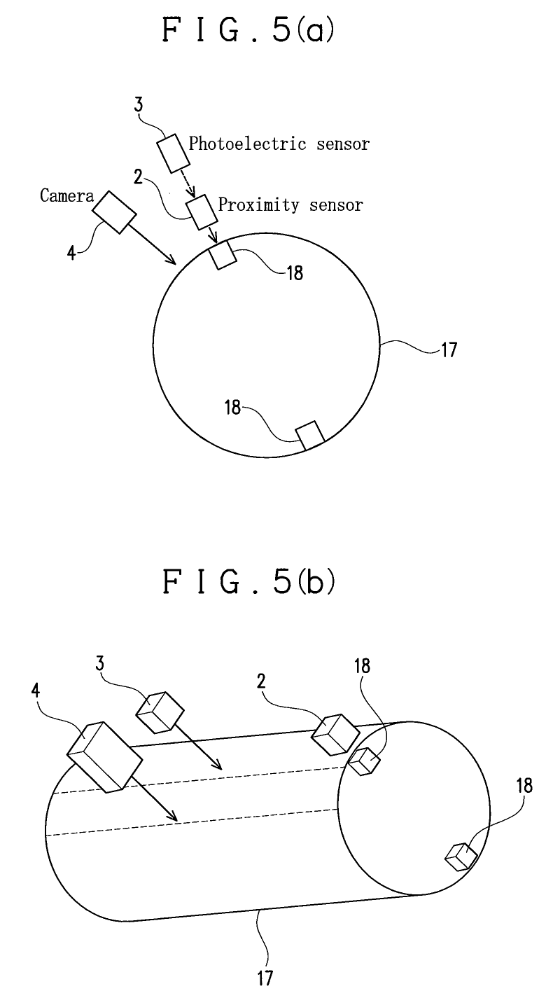

The proximity sensor 2 is generally of three types, namely a high-frequency emission type utilizing electromagnetic induction, a magnetic type using magnet and a capacitance type utilizing change of capacitance, and any type may be used. In a case of the high-frequency emission type, as illustrated in FIG.3 and FIGS. 5(a) and 5(b), detection members 18, 18 made of metal or the like are disposed at two points of an impression cylinder 17 in the circumferential direction thereof, and the proximity sensor 2 emits high-frequency waves onto the detection members 18, 18. With this arrangement, when a print medium is conveyed to the impression cylinder 17, the frequency of high-frequency oscillation is changed. This change is detected by the proximity sensor 2, thereby enabling the leading edge of the print medium to be detected.

The photoelectric sensor 3 is made up of a light emitting element and a light sensitive element. Light emitted from the light emitting element is directed to a print medium and reflected, and this reflected light is received by the light sensitive element. Thus, the leading edge of the print medium can be detected. The proximity sensor 2 and the photoelectric sensor 3 are so arranged that, after a predetermined time has been elapsed since the detection of the leading edge of the print medium by the proximity sensor 2, the photoelectric sensor 3 can detect the leading edge of the print medium. It is possible to omit the possibility of erroneous detection due to the same cause, thus enhancing the reliability of the sensors by using the different types of sensors, while it is possible to use the same type of sensors for the above operation.

Now, the description will be made for the operation of detection of the color density of a print medium printed by the printing press.

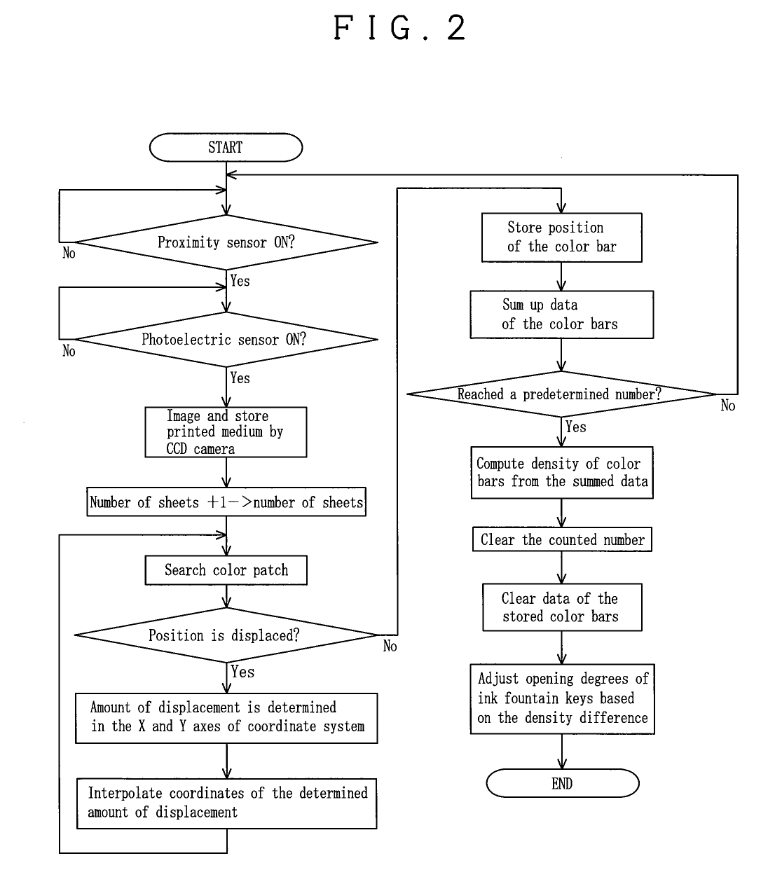

As illustrated in a flowchart of FIG. 2, the proximity sensor 2 is turned on upon detection of the leading edge of a print medium by the proximity sensor 2, and then the photoelectric sensor 3 is turned on upon detection of the leading edge of the print medium by the photoelectric sensor 3. Whereby, an imaging start signal is outputted from the imaging time setting section 5 to the CCD camera 4. The CCD camera 4 then starts imaging of the print medium and stores as data an image of the entire area of the imaged print medium. Upon finish of the imaging, it is counted as “one piece of sheet” and then a basic color patch of the imaged and stored print medium is searched out on the basis of the previously stored shape and color information of the basic color patch. At this moment, it is checked whether the positional displacement of the imaged print medium has occurred. When the positional displacement has occurred, the amount of displacement is determined in the X and Y axes of a coordinate system, then the coordinates of the determined amount of displacement are interpolated and again a basic color patch is searched out. If the interpolation cannot be achieved even after interpolation processings are performed 5 times, an error indication is made and the subsequent processings are interrupted. Then, after the position of the basic color patch has been searched out after performing the interpolation processing, the position of the entire color bar having the color patches aligned side by side with the basic color patch is stored, and the data of color bars processed are summed up. At this moment, it is checked whether processed print mediums have been reached a predetermined number. If not reached, the same processings as those mentioned above are made. If reached, the density of the color bars is determined by computation from the summed data. After this, the counted number is cleared and the data of the stored color bars is cleared. Then, the opening degrees of the ink fountain keys are adjusted on the basis of the determined density values and thus the control is finished.

Each printing unit of the printing section I, which is not illustrated in detail, is of a general type. For example, as illustrated in FIG. 3, each printing unit is made up of a set of essential components, which include a plate cylinder 19, a rubber cylinder 20 and an impression cylinder 17, so that, after printing, each sheet is conveyed to the next printing unit or the discharging section via a transfer cylinder 21. A printing plate is mounted on the plate cylinder 19 in each printing unit. Ink and water are supplied onto each printing plate and ink is transferred onto the corresponding rubber cylinder 20 by the printing plate. Ink transferred onto the rubber cylinder 20 is further transferred onto a printing sheet conveyed while being held between the rubber cylinder 20 and the impression cylinder 17. Whereby, each printing sheet supplied from the sheet supply section J can be printed by the printing plates respectively mounted on the plate cylinders 19. In this operation, each printing plate prints a basic color image of C, M, Y and K with providing a non-printing area along the edge of each printing sheet, and as illustrated in FIG. 6, a color bar B (in this case, it is printed with four colors, but may be printed three colors, two colors or five or more colors, or may be printed with one color only in some cases) is printed along a terminal end portion in the non-printing area of a printing sheet, which extends in the lateral direction orthogonal to the sheet conveying direction. The color bar B may be printed in a start end portion in the conveying direction or both in the start end portion and the terminal end portion.

In the above embodiment, with the CCD camera 4 secured in position, a print medium is conveyed so that imaging for capturing an image of the print medium can be started. Alternatively, a moving means may be provided to be capable of moving the CCD camera 4 so that an image of a print medium is captured by moving the CCD camera 4 while the print medium is kept unmoved.

This specification is by no means intended to restrict the present invention to the preferred embodiments set forth therein. Various modifications to the method and apparatus for measuring color density of a color bar, and the printing press equipped with the color density measuring device, as described herein, may be made by those skilled in the art without departing from the spirit and scope of the present invention as defined in the appended claims.

What is claimed is:

1. A method of measuring the color density of a color bar of each of print mediums in a printing press, in which each of print mediums is printed and imaged before it is discharged from the printing press, and the color density of the imaged print medium is measured, said method comprising:
storing the shape and the color information of a basic color patch of a color bar of a print medium;
imaging the entire area of each of printed print mediums;
storing an image of the entire area of the imaged print medium;
scanning a particular area of the stored image, said particular area containing a basic color patch of a color bar of the imaged print medium, on the basis of the previously stored shape and color information of the basic color patch, thereby searching out the basic color patch of the imaged print medium;
storing the position of the searched out basic color patch of the print medium; and
recognizing the position of the color bar from the stored position of the basic color patch and measuring the color density of the color bar.

2. A method of measuring the color density of a color bar according to claim 1, further comprising checking whether the position of the basic color patch of the stored image of each of second and subsequent print mediums is matched to the position of the basic color patch of the stored image of a first print medium, so that if they are not matched, the amount of displacement in the x and y axes of a coordinate system is computed, and coordinate interpolation is performed according to the result of the computation.

3. A method of measuring the color density of a color bar according to claim 1, wherein the particular area has a lateral width greater than the lateral width of the basic color patch that is located at the center along the lateral direction of each of the print mediums, and each of the print mediums is scanned over the lateral width of the particular area in a direction in which each of the print mediums is conveyed.

4. A color density measuring apparatus for measuring the color density of each of print mediums in a printing press, in which an imaging means is disposed to image each of printed print mediums before it is discharged from the printing press, said apparatus comprising:
a basic color patch storing means for storing the shape and the color information of a basic color patch of a color bar of a print medium;
an image storing means for storing an image of the entire area of each of the print mediums imaged by the imaging means;
a scanning means for scanning a particular area containing the basic color patch of the image stored by the image storing means;
a position storing means for storing the position of the basic color patch of each of the printed mediums by searching out the basic color patch of each of the print mediums by scanning the particular area on the basis of the shape and the color information of the basic color patch stored by the basic color patch storing means;
a position recognition means for recognizing the position of the color bar on the basis of the position of the basic color patch stored by the position storing means; and
a color density measuring means for measuring the color density of the color bar recognized by the position recognition means.

5. A color density measuring apparatus according to claim 4, further comprising an interpolation means that checks whether the position of the basic color patch of the stored image of each of second and subsequent print mediums is matched to the position of the basic color patch of the stored image of a first print medium, so that if they are not matched, the amount of displacement in the x and y axes of a coordinate system is computed, and coordinate interpolation is performed by the interpolation means according to the result of the computation.

6. A color density measuring apparatus according to claim 4, wherein the particular area has a lateral width greater than the lateral width of the basic color patch that is located at a center along the lateral direction of each of the print mediums, and each of the print mediums is scanned over the lateral width of the particular area in a direction in which each of the print mediums is conveyed.

7. A printing press comprising the color density measuring apparatus according to claim 4, a computation means for computing the density difference between a color density measured by the color density measuring means and a preset color density, and an ink amount adjusting means for adjusting the amount of ink to be supplied for each of plural ink fountain keys according to the density difference computed by the computation means.

8. A printing press according to claim 7, wherein the print mediums are printed sheets of paper, said printing press further comprising a first detection means for detecting the leading edge of an upcoming print medium in the conveying direction; a second detection means for detecting the leading edge of the upcoming print medium after elapsing a predetermined time from a time at which the first detection means has detected the same, and an imaging start instruction means for outputting an imaging start signal to the imaging means on the basis of an ON signal of the first detection means and an ON signal of the second detection means.

9. A printing press according to claim 8, further comprising a conveying speed detection means for detecting the conveying speed of the sheets of paper, said speed detection means being provided in a sheet supply section for supplying unprinted sheets of paper, and a speed limiting means for limiting the maximum conveying speed of the sheet supply section on the basis of a conveying speed value transmitted from the conveying speed detection means so as not to convey the sheets of paper at a speed equal to or higher than the limit imaging speed of the imaging means, at which the imaging means cannot appropriately perform imaging.

10. A method of measuring the color density of a color bar according to claim 2, wherein the particular area has a lateral width greater than the lateral width of the basic color patch that is located at the center along the lateral direction of each of the print mediums, and each of the print mediums is scanned over the lateral width of the particular area in a direction in which each of the print mediums is conveyed.

11. A color density measuring apparatus according to claim 5, wherein the particular area has a lateral width greater than the lateral width of the basic color patch that is located at a center along the lateral direction of each of the print mediums, and each of the print mediums is scanned over the lateral width of the particular area in a direction in which each of the print mediums is conveyed.

12. A printing press comprising the color density measuring apparatus according to claim 6, a computation means for computing the density difference between a color density measured by the color density measuring means and a preset color density, and an ink amount adjusting means for adjusting the amount of ink to be supplied for each of plural ink fountain keys according to the density difference computed by the computation means.
